(19) United States
(12) Patent Application Publication
(10) Pub. No.: US 2020/0031013 A1
(43) Pub. Date: Jan. 30, 2020

(54) REPLACEABLE THREAD INSERT WITH EXTERNAL FRICTION SURFACE AND METHOD

(71) Applicant: BID GROUP TECHNOLOGIES LTD., Prince George (CA)

(72) Inventors: Stephane Horth, Boisbriand (CA); Dominyk Roy, Sainte-Marie (CA); Jacques Maugery, Saint-Georges (CA)

(21) Appl. No.: 16/521,698

(22) Filed: Jul. 25, 2019

Related U.S. Application Data
(60) Provisional application No. 62/703,277, filed on Jul. 25, 2018.

(51) Int. Cl. B27C 1/14; B27L 11/00; B27G 13/00

(52) U.S. Cl. CPC B27C 1/14; B27G 13/002; B27L 11/005

(57) ABSTRACT

The present discloses is a replaceable threaded insert for mounting a knife assembly or knife holder to a chipping head. The replaceable threaded insert has a generally frustoconical shape allowing the insert to be slid in an opening of the chipping head. The inner portion of the insert is threaded. A knife holder may be positioned over the chipping head and a bolt may be inserted in an aperture of the knife holder and in the threaded inner portion of the threaded insert, thus attaching the knife holder to the chipping head.

### CROSS-REFERENCE TO RELATED APPLICATIONS

The present patent application claims the benefits of priority of U.S. Provisional Patent Application No. 62/703,277, entitled “REPLACEABLE THREAD INSERTS WITH EXTERNAL FRICTION SURFACE AND METHOD”, and filed at the United States Patent and Trademark Office on Jul. 25, 2018, the content of which is incorporated herein by reference.

### FIELD OF THE INVENTION

The present invention generally relates to attachment of wood cutting apparatus.

Particularly, the present invention relates to attachment of wood cutting knife, knife holder, knife assembly and method of using the same.

### BACKGROUND OF THE INVENTION

The knife assembly are held by a bolt. The bolt is screwed into threads in the chipping head or chipping assembly. The bolt, for this type of application, is screwed with a high initial torque. Due to the nature of the mounting and use, the replacement of the bolts is required periodically. The threads in the chipping head work pair with the bolt. The use of existing thread inserts (threads on the inside diameter and threads on the outside diameter) requires regular maintenance and the existing thread inserts need to be replaced or repaired periodically. Eventually this maintenance will damage the threads in the chipping head.

### SUMMARY OF THE INVENTION

As opposed to the existing method of replaceable thread insert, threads on the inside diameter (ID) and threads on the outside diameter (OD), the invention does not require any threads on the outside surface.

The outer section of the replaceable thread inserts 60 with external friction surface consists of one or more inclined or tapered planes. The inner section of the part can be threaded or designed to receive a stud or any kind of nut that would allow the replaceable thread inserts 60 to be maintained in place with the use of a bolt 50 or a nut 70.

The knife assembly and method according to the present invention aims at facilitating the manufacturing of the chipping head.

Also, in relationship to the maintenance, this invention allows to replace worn or damaged threads without having to machine the chipping head.

One or more inclined or tapered planes allow to hold the replaceable threads with no other hardware or assembly.

Friction in relation to the surfaces in contact on the exterior walls of the replaceable thread inserts 60 ensures its good maintenance while allowing a simple dismantling without damage.

Given the limited access to the rear of the assembly, the replaceable thread inserts 60 in connection with this invention does not require mechanical assembly involving a retaining part or a bolt. Only friction ensures its solid and faithful holding.

Some of the advantages of a replaceable thread inserts comprise having treaded surface that is strong enough to be mounted and/or dismounted from a chipping assembly, ease the manufacturing as the thread inserts dimensions have a higher tolerance to errors, the metal, typically steel, used to make the inserts and the chipping assembly may be different, the force applied by the bolt against the frustoconical inserts strengthens the assembly instead of collapsing and the area of the external surface of the inserts is greater than the area of the internal threaded surface.

In one aspect of the invention, a replaceable threaded insert for mounting a tool to a chipping assembly is provided. The replaceable threaded insert comprises a first extremity defining a first area, the first extremity comprising a passage adapted to receive a body portion of a bolt, a second extremity defining a second area, the second area being greater than the first area and an external tapered surface delimited by the first and second extremities, the external slanted surface being adapted to be pressed against an internal surface of an aperture of the chipping assembly.

The passage of the replaceable threaded insert may be threaded and the body portion may be screwed into the threaded passage of the replaceable threaded insert. The bolt may extend from the passage of the replaceable threaded and being mounted with a nut. A threaded bolt may extend from the first extremity of the threaded insert and may be adapted to slide in an aperture of the tool.

The angle of the tapered opening of the chipping head being between 0.01 and 15 degrees and the internal surface of the aperture of the chipping head may be tapered. The angle of the tapered opening of the chipping head may be about equal to the angle of the external tapered surface of the replaceable thread insert.

The tool may be a knife holder and the chipping assembly may be a chipping head.

In another aspect of the invention, a method for removably mounting a tool to a chipping assembly is provided. The method comprises sliding a tapered insert in an opening of the chipping assembly, positioning a bolt in an opening of the tool aligned with the opening of the chipping assembly and pressing the tapered insert in the opening of the chipping assembly by tightening the bolt to contact the tool against the chipping assembly.

The pressing of the tapered insert in the opening of the chipping assembly may removably hold the tapered insert in the opening of the chipping assembly. The pressing of the tapered insert in the opening may create friction between an internal surface of the opening of the chipping assembly and an external surface of the tapered insert.

Increasing torque on the bolt may further press the tapered insert to a tapered inside surface of the aperture of the chipping assembly.

The method of claim 10, the tool being a knife holder and the chipping assembly being a chipping head.

In yet another aspect of the invention, a method for removing a tool mounted to a chipping assembly is provided. The method comprises removing a bolt from an aperture of a threaded tapered insert, the bolt holding the tool to the chipping assembly, removing the unmounted knife holder from the chipping assembly and applying a force on a top portion of a tapered insert positioned in the aperture of the chipping assembly to dislodge the tapered insert from the aperture of the chipping assembly.

A removing tool may be used to apply the force on the top portion of the tapered insert. The removing tool may comprise an elongated member adapted to be slid in the aperture of the threaded tapered insert and to contact and apply the force on the top portion of the threaded tapered insert. The force applied on the top of the threaded tapered insert may dislodge the threaded tapered insert from the aperture of the chipping assembly. The elongated member may further comprise an edge adapted to apply force on the top of the threaded tapered insert.

The tool may be a knife holder and the chipping assembly may be a chipping head.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a perspective view of a complete chipping assembly using an embodiment of replaceable thread inserts in accordance with the principles of the present invention.

FIG. 2 is a side view of an exemplary clamping assembly to be installed on a chipping assembly and using an embodiment of replaceable thread inserts in accordance with the principles of the present invention.

FIG. 3 is an exploded perspective view of the knife assembly bolt of FIG. 2.

FIG. 4 is a sectional side view of the knife assembly bolt of FIG. 2 as mounted on a chipping assembly.

FIG. 5 is a front view of another exemplary clamping assembly installed on a chipping assembly and using an embodiment of replaceable thread inserts in accordance with the principles of the present invention.

FIG. 6 is a sectional front view of the knife assembly of FIG. 5 showing a knife holder and a chipping assembly.

FIG. 7 is a front view of the knife assembly of FIG. 5 showed with the bolt being outside of the opening.

FIG. 8 is a front section view of the knife assembly of FIG. 7 showed with the bolt being outside of the opening.

FIG. 9 is a sectional side view of another embodiment of the knife assembly bolt of FIG. 2 as mounted on a chipping assembly.

FIGS. 10A to 10C are perspective views showing 3 embodiments of a replaceable inserts with external friction surface inserts in accordance with the principles of the present invention.

FIG. 11 is a sectional side view of an embodiment of a thread inserts shown being inserted in a chipping assembly in accordance with the principles of the present invention.

FIG. 12 is a side view of an embodiment of a tool for removing a thread inserts from a chipping assembly in accordance with the principles of the present invention.

FIG. 13 is a side section view of the tool of FIG. 12 shown when pushing on a thread inserts within the opening of a chipping assembly.

### DETAILED DESCRIPTION OF THE PREFERRED EMBODIMENT

A novel replaceable thread inserts 60 with external friction surface and method will be described hereinafter. Although the invention is described in terms of specific illustrative embodiments, it is to be understood that the embodiments described herein are by way of example only and that the scope of the invention is not intended to be limited thereby.

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention, and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention is to be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element.

With regard to any method claim including a condition precedent step, such method requires the condition precedent to be met and the step to be performed at least once during performance of the claimed method.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” When used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

The detailed disclosure herein refers to the concept of chipping. In the present disclosure, chipping refers to the operation of removing chunks from a log as opposed to shredding which refers to reducing or cut into very small strips or reducing to shreds. In the present disclosure, chipping may also refer to grinding, which means rubbing or wearing an external surface of the wood log, to cutting and/or to reducing.

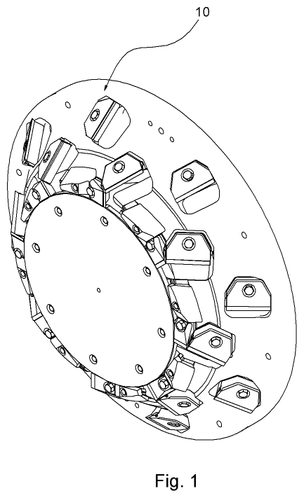

Referring now to FIG. 1, an exemplary chipping head or chipping assembly 10 is illustrated. The chipping head or chipping assembly 10 is typically used in a log chipping line to create substantially flat surfaces on logs.

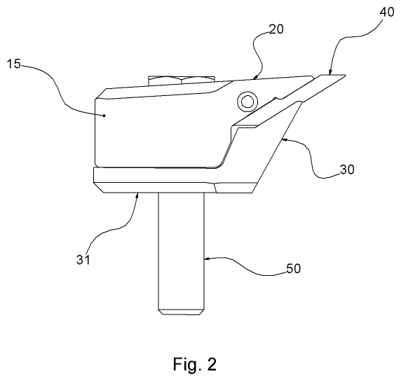

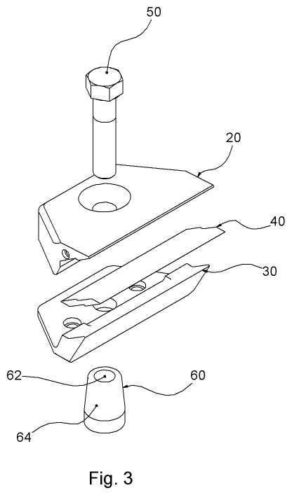

Referring now to FIGS. 2 to 4, an exemplary knife assembly 15 is shown. In such an embodiment, the knife assembly 15 comprises a knife holder 30, a knife clamp 20 and a knife 40. Broadly, the knife assembly 15 is adapted to mount yet dismount the knife 40. The knife assembly 15 is adapted to be mounted on the chipping assembly 10.

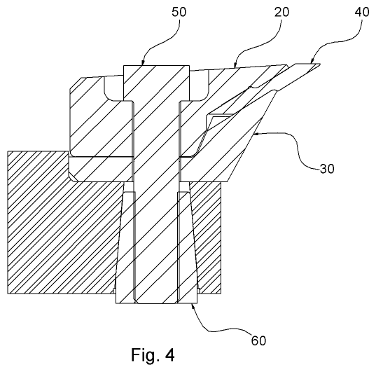

Referring now to FIG. 4, an embodiment of a knife holder 30 is shown mounted to the chipping assembly 10. In such an embodiment, the lower portion of the knife holder 30 is supported by the chipping assembly 10 on both sides of the aperture 12.

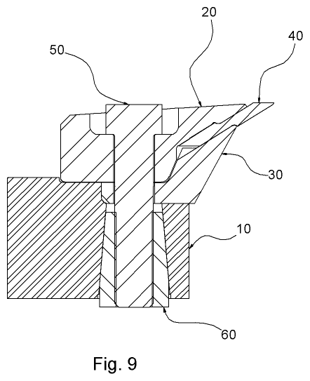

Referring now to FIG. 9, another embodiment of a knife holder 30 is shown. In such an embodiment, the lower portion of the knife holder 30 is supported only on one side of the aperture 12 of the chipping assembly 10. The clamping portion 20 of the knife assembly 15 being supported by the chipping assembly 10 on the other side of the aperture 12.

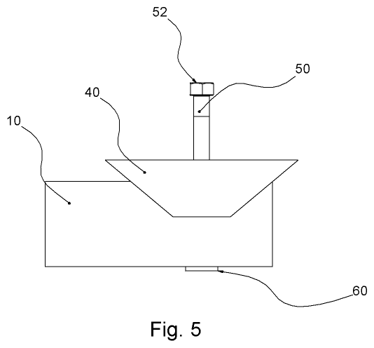

Now referring to FIGS. 5 to 8 an embodiment of knife holder 30 adapted to receive a bolt 50 to mount the knife holder 30 on the chipping assembly 10 is shown. In such an embodiment, the knife holder 30 and the clamp 20 each comprises an opening 32 and 22 respectively adapted to receive a bolt 50. Understandably, the openings 32 and 22 are shaped to slidingly receive the bolt 50.

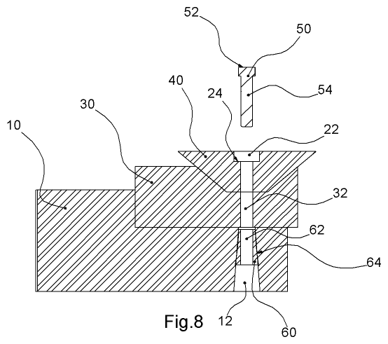

As shown in FIG. 8, the bolt 50 first passes through the opening 22 within the clamp 20 and then in the opening 32 of the knife holder 30. In the embodiments shown in FIGS. 5 to 8, the opening 22 of the clamp 20 may comprises an enlarged portion 24 adapted to hold the bolt head 52. The enlarged portion 24 may be slanted, tapered or may form a lip or an edge to retain the bolt head 52. When the bolt 50 is inserted in the openings 22 and 32, the clamp portion 20 and the knife holder 30 hold the knife 40 in position by catching the knife 40 in a vice.

Referring back to FIG. 2, an exemplary of a knife assembly 15 is shown. In such an embodiment, the knife assembly 15 comprises a knife holder 30 having an opening 32 substantially perpendicular to the bottom 31 of the knife holder or substantially vertical. Such configuration allows accommodating the passage of the bolt 50 through the knife holder 30.

The chipping assembly 10 further comprises one or more inclined or tapered plane openings 12 adapted to receive a lower body 54 of the bolt 50. Thus, the bolt 50 passes through the clamp 20, the knife holder 30 and chipping assembly 10.

Referring now to FIGS. 5 to 8, the tapered opening 12 of the chipping assembly 10 is adapted to receive a tapered insert 60. Understandably, in a typical embodiment, the insert 60 comprises a threaded aperture or opening 62 adapted to receive the threaded body portion 54 of the bolt 50. In some embodiments, the threaded insert 60 has an external tapered or slanted portion 64 adapted to be received by the tapered opening 12. As the threaded body portion 54 of the bolt 50 is tightened in the threaded opening 62 of the threaded insert 60, the external tapered surface 64 is pushed again the mating receiving tapered opening 12. Such pression creates a force capable of holding the knife 40 between clamp 20 and the knife holder 30.

One skilled in the art shall understand that an insert 60 as disclosed here may be used in the mounting of any tool or implement adapted to be mounted to the chipping assembly 10 and is not limited to mount an exemplary knife holder or knife assembly to the chipping assembly 10. Understandably, any other type of tool or implement known in the art may be used without limiting the scope of the present invention.

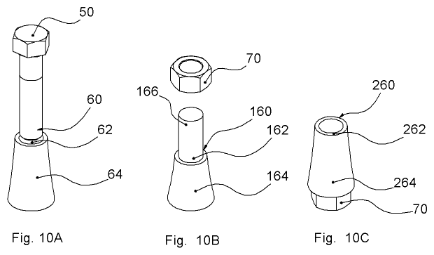

In other embodiments, as shown in FIGS. 10A to 10C, a nut 70 is adapted to be mounted on the one end of the bolt 50 which extends below the threaded insert 60.

The external surface 64 of the threaded insert 60 and the internal surface of the opening 12 are typically shaped or made to allow the threaded insert 60 to slide in or out of the opening 12.

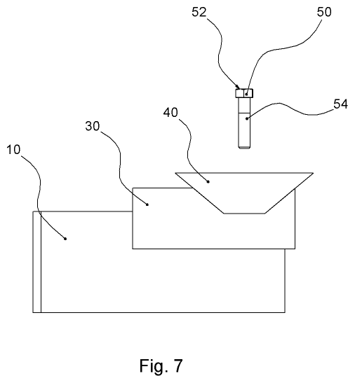

The knife 40 is then held in position by a bolt 50 screwed into the holder or by a nut 70 (FIG. 7) screwed onto the stud 61 (FIG. 7).

Referring now to FIGS. 10A to 10C, different embodiments of replaceable thread inserts 60 are shown. Referring to FIG. 1, the insert 60 comprises an inside threaded surface 62 and an inclined or tapered outside surface 64. As explained above, the outside surface is typically not threaded.

Referring now to FIG. 10B, a second embodiment of a replaceable thread insert 160 is shown. The thread insert 160 comprises a threaded stud, pin or shaft 166 protruding from the inside portion 162 of the insert 160. The insert 160 also comprises an inclined or tapered plane on the outside surface 164.

Referring now to FIG. 10C, a third embodiment of a replaceable thread insert 260 with external friction surface 264 comprises a nut 70 mounted to the bottom portion of the insert 260. In some embodiment, the nut 70 is welded to the bottom portion of the insert 260. The nut 70 comprises a threaded opening which is substantially aligned with the lower opening 262 of the insert 260. The insert 260 further comprises an inclined or tapered plane on the outside surface 264.

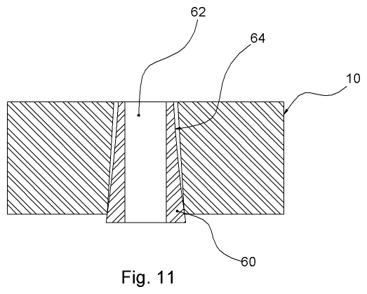

Referring now to FIG. 11, an exemplary threaded insert 60 is shown inserted in the opening 12 of the chipping assembly 10. In such an embodiment, the angle of the inclined or tapered plane openings 12 of the chipping assembly 10 substantially correspond to the angle of the outside surface 64 of the replaceable thread n 60.

Preferably, the angle of the inclined or tapered outside plane openings 664, 164 and 264 of the replaceable thread insert 60, 160, 269 ranges between 0.01 and 15 degrees.

Referring back to FIG. 8, the body portion 54 of the bolt 50 is preferably screwed into a threaded opening 62 of the replaceable thread insert 60.

In use, the replaceable thread insert 60, 160, 260 is slid into an inclined or tapered plane opening, preferably in an opening 12 of the chipping assembly 10, as shown in

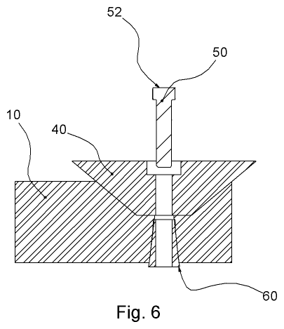

FIGS. 5 and 6. The knife holder 30 sits on or is received by the chipping assembly 10. The knife 40 and the clamp 20 are then positioned. The bolt 50 or the nut 70 can then be inserted on the replaceable thread insert 60, 160, 260.

A minimum initial torque is then applied on the bolt 50 so the friction allows the surface 62, 162, 262 to retain the replaceable thread insert with external friction surface 60, 160, 260 as shown in FIGS. 6.

Once the assembly has been completed, the nominal torque is applied to the bolt 50 or the nut 70. After nominal torque is applied, the knife assembly 15 may be loosened to replace or turn the knife 40 to obtain a new cutting edge.

The replaceable thread insert 60, 160, 260 will remain in position during changes of knife 40.

The replaceable thread insert 60, 160, 260 may be completely removed from the opening 12 to complete its maintenance.

To remove the replaceable thread insert 60, 160, 260, one may remove the bolt 50 or the nut 70 by untightening it. Once the bolt 50 or nut 70 is removed, the replaceable thread insert 60, 160, 260 is generally stuck or retained within the opening 12 of the chipping assembly 10. By being maintained in the opening 12, the insert 60, 160, 260 may drop or fall being the chipping assembly. After the bolt 50 or nut 70 is removed, the clamp 20 is removed from the top of the knife 40. The released knife 40 may then be removed followed by the knife holder 30.

When the bolt 50, the clamp 20, the knife 40 and the knife holder 30 are removed, the replaceable thread insert 60, 160, 260 may be disengaged. In some embodiments, the bolt 50 or the nut 70 are threaded along the entire length of the body 54. A blunt mass or any tool to provide an impact force is used to hit the head 52 of bolt 50 or the nut 70 to disengage the replaceable thread insert 60, 62 from the chipping assembly 10. One skilled in the art shall understand that when the bolt 50 or nut 70 is loosened, some space is created between the head 52 and the receiving portion 24 of the clamp 20.

When an insert 160 is used, it is then necessary to hit the stud 160 with a blunt mass to disengage the replaceable thread insert 61 from the chipping assembly 10.

One may then use the previous method to install a new replaceable thread insert 60, 160, 260 on the chipping assembly 10.

Preferably the material used for making the replaceable thread insert with external surface 60, 160, 260 may be selected from corresponding material family to the head 52. The selected material generally aims at creating a frictional jamming between the insert 60, 160, 260 and the opening 12.

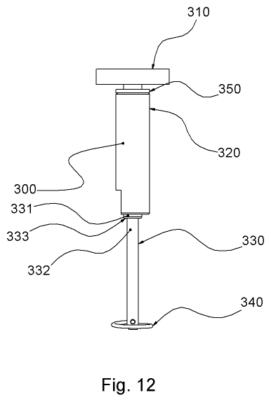

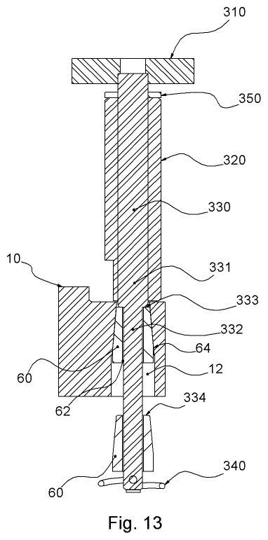

Referring now to FIGS. 12 and 13, a tool 300 for dislodging a thread insert 60 is shown. The tool 300 generally comprises a main body 320 and elongated member 330 extending within the said body 320. The elongated member 330 is shaped to fit within the opening or passage 62 of a thread insert 60 at one end and to fit within the opening 12 of the chipping assembly 10 at another end. The elongated member 330 comprises a top portion 333, and a lower portion 334. The top portion is shaped to fit within the opening 12 of the chipping assembly. The lower portion is shaped to fit within the opening or passage 62 of a thread insert 60. Understandably, the top portion is wider than the lower portion. The width or diameter of the top portion of the elongated member 330 must be smaller than the opening 12 of the chipping assembly 10 but greater than the opening 62 of the insert 60. In some embodiments, the elongated member 330 is shaped as a cylinder. The elongated member 330 generally comprises a lip or edge formed between the top portion and the lower portion. Such edge allows the elongated member 330 to be pushed against the top portion of the insert 60.

The tool 300 further comprises a butt 350 at one extremity. The butt 350 is adapted to receive a strike from any type of hammer, mallet or the like. In some embodiments, the butt 350 is a disk attached to the top portion of the elongated member 330. In the embodiment as shown in FIG. 12, the butt 310 is welded to the top portion of the elongated member 330.

In some embodiments of the tool 300, a casing or handle 320 is provided to slidingly receive the elongated member 330. The casing 320 may further comprises a dampening portion 350, such as an O-ring, adapted to absorb the shock of the 310 against the casing. Understandably, the casing may have any shape suited to be used with the particulars of chipping assemblies 10.

The elongated member 330 may comprise a retaining portion 340 at its extremity. The retaining portion is adapted to hold on the dislodged insert 60 to avoid losing it under the chipping assembly 10. In some embodiments, the retaining portion 340 is a spring pin 340 generally adapted to have a length or width being greater than the width or diameter of the opening 62 of the thread insert 60. Typically, the spring pin 340 is inserted in an aperture or passage across the elongated member 330. Understandably, any other mechanism known in the art to allow the thread insert 60 to be held on the elongated member 330 after being dislodged may be used with the present invention.

In use, the elongated member 330 of the tool 300 is inserted within the apertures 12 and 62 of the chipping assembly 10 until the edge contacts the top portion of the insert 60, the lower portion of the elongated member being inserted in the aperture 62 of the insert 60 only. In a typical embodiment, prior to inserting the tool 300, the knife assembly 15 is removed from the chipping assembly 10 as it is not longer held by the bolt 50. After being inserted, a hammering tool is used to hit the butt 350 of the tool 300. Such an impact dislodges the insert 60 from the aperture 12 of the chipping assembly 10.

In other embodiments, after being inserted, the retaining member 340 is installed on the extremity of the lower portion being outside of the aperture 62 of the insert 60.

In yet other embodiments, a user may hold the tool 300 by having the casing 320 in hand and hitting on the butt 350 of the tool. Such impacts force the elongated member 330 to slide within the casing 320 to provide a force to dislodge the insert 60.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A replaceable threaded insert for mounting a tool to a chipping assembly, the replaceable threaded insert comprising:
a first extremity defining a first area, the first extremity comprising a passage adapted to receive a body portion of a bolt;
a second extremity defining a second area, the second area being greater than the first area; and
an external tapered surface delimited by the first and second extremities, the external slanted surface being adapted to be pressed against an internal surface of an aperture of the chipping assembly.

2. The replaceable threaded insert of claim 1, the passage of the replaceable threaded insert being threaded.

3. The replaceable threaded insert of claim 2, the body portion being screwed into the threaded passage of the replaceable threaded insert.

4. The replaceable threaded insert of claim 1, the bolt extending from the passage of the replaceable threaded insert and being mounted with a nut.

5. The replaceable threaded insert of claim 1, a threaded bolt extending from the first extremity of the threaded insert and being adapted to slide in an aperture of the tool.

6. The replaceable threaded insert of claim 1, the angle of the tapered opening of the chipping head being between 0.01 and 15 degrees.

7. The replaceable threaded insert of claim 1, the internal surface of the aperture of the chipping head being tapered.

8. The replaceable threaded insert of claim 7, the angle of the tapered opening of the chipping head being about equal to the angle of the external tapered surface of the replaceable thread insert.

9. The replaceable threaded insert of claim 1, the tool being a knife holder and the chipping assembly being a chipping head.

10. A method for removably mounting a tool to a chipping assembly, the method comprising:
sliding a tapered insert in an opening of the chipping assembly;
positioning a bolt in an opening of the tool aligned with the opening of the chipping assembly;
pressing the tapered insert in the opening of the chipping assembly by tightening the bolt to contact the tool against the chipping assembly.

11. The method of claim 10, the pressing the tapered insert in the opening of the chipping assembly removably holding the tapered insert in the opening of the chipping assembly.

12. The method of claim 11, the pressing the tapered insert in the opening creating friction between an internal surface of the opening of the chipping assembly and an external surface of the tapered insert.

13. The method of claim 10, increasing torque on the bolt further pressing the tapered insert to a tapered inside surface of the aperture of the chipping assembly.

14. The method of claim 10, the tool being a knife holder and the chipping assembly being a chipping head.

15. A method for removing a tool mounted to a chipping assembly, the method comprising:
removing a bolt from an aperture of a threaded tapered insert, the bolt holding the tool to the chipping assembly;
removing the unmounted knife holder from the chipping assembly;
applying a force on a top portion of a tapered insert positioned in the aperture of the chipping assembly to dislodge the tapered insert from the aperture of the chipping assembly.

16. The method of claim 15, a removing tool being used to apply the force on the top portion of the tapered insert.

17. The method of claim 16, the removing tool comprising an elongated member adapted to be slid in the aperture of the threaded tapered insert and to contact and apply the force on the top portion of the threaded tapered insert.

18. The method of claim 17, the force applied on the top of the threaded tapered insert dislodging the threaded tapered insert from the aperture of the chipping assembly.

19. The method of claim 17, the elongated member further comprising an edge adapted to apply force on the top of the threaded tapered insert.

20. The method of claim 15, the tool being a knife holder and the chipping assembly being a chipping head.
